(19) United States
(12) Patent Application Publication
(10) Pub. No.: US 2010/0201638 A1
(43) Pub. Date: Aug. 12, 2010

(54) OPERATION METHOD OF TOUCH PAD WITH MULTIPLE FUNCTION MODES, INTEGRATION SYSTEM THEREOF, AND COMPUTER PROGRAM PRODUCT USING THE OPERATION METHOD

(75) Inventors: Ming-Chung Peng, Taipei City (TW); You-Chi Liu, Taipei City (TW); Shu-Fen Liao, Taipei City (TW); Shu-Hua Tsai, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/414,664

(22) Filed: Mar. 31, 2009

(30) Foreign Application Priority Data
Feb. 11, 2009 (TW) 98104328

(51) Int. Cl. G06F 3/041

(52) U.S. Cl. 345/173

(57) ABSTRACT

A touch pad operation method with multiple function modes, an integration system, and a computer program product are provided. A first signal is received and whether the first signal conforms to a trigger condition is determined. If the first signal conforms to the trigger condition and exists continuously, the touch pad is switched from a first function mode to a second function mode and maintained therein. The second function mode includes a plurality of functions of a second kind, and each of these functions is respectively corresponding to an area on the touch pad. When a second signal is received through the touch pad and the first signal still exists, one of the second kind of functions is executed according to a coordinate variation corresponding to the second signal. Thereby, the functionality of the touch pad is not limited by its original settings and the convenience of operation is increased.

### CROSS-REFERENCE TO RELATED APPLICATION

This application claims the priority benefit of Taiwan application serial no. 98104328, filed Feb. 11, 2009. The entirety of the above-mentioned patent application is hereby incorporated by reference herein and made a part of specification.

### BACKGROUND OF THE INVENTION

1. Field of the Invention

The present invention generally relates to an operation method of a touch pad, and more particularly, to an operation method of a touch pad which integrates multiple function modes and related applications thereof.

2. Description of Related Art

The hardware/software infrastructure of desktop computers has been constantly developed along with the computer technology. However, notebook computers have been broadly accepted by many people due to their high mobility. Thus, computer product manufacturers are focusing more and more on the design and development of notebook computer related products. Generally speaking, a notebook computer not only has to be integrated with various functions to meet different requirements of consumers but has to be designed light-weight and slim in its appearance to be conveniently carried around.

In order to allow a user to operate a notebook computer conveniently without carrying a mouse around, a touch pad is usually disposed below the keyboard of the notebook computer to replace the mouse. An existing touch pads usually has two buttons and a touch area, wherein the two buttons act as the left and right buttons of a mouse, and the touch area allows a user to move the cursor around by running his/her finger thereon.

Since touch pads are designed to replace mice, only those conventional mouse functions such as cursor control and object selection are provided with the touch pads, and signals corresponding to different operations are pre-planed so that an operating system can respond correspondingly. However, more and more different kinds of functions are being integrated into notebook computers, wherein the functions and user interfaces of multimedia application programs are becoming more and more complicated. Accordingly, the touch pads which support only conventional mouse functions are not convenient to use therefore may bring unpleasant experience to the users.

### SUMMARY OF THE INVENTION

Accordingly, the present invention is directed to an operation method of a touch pad with multiple function modes, wherein the function modes are integrated into the same touch pad.

The present invention is directed to an integration system of a touch pad with multiple function modes, wherein the functionality of the touch pad is not limited by its original settings but becomes more diversified.

The present invention is directed to a computer program product, wherein program instructions recorded therein are suitable for being loaded into and executed by a computer system such that a user can perform various operations of the computer system through a touch pad.

The present invention provides an operation method of a touch pad with multiple function modes, wherein the touch pad is set to a first function mode. The operation method includes following steps. First, a first signal is received, and whether the first signal conforms to a trigger condition is determined. Then, if the first signal conforms to the trigger condition and exists continuously, the touch pad is switched to and maintained in a second function mode, wherein the second function mode includes a plurality of functions of a second kind, and each of the second kind of functions is respectively corresponding to an area on the touch pad. If a second signal is received through the touch pad and the first signal still exists, a corresponding one of the second kind of functions is executed according to a coordinate variation corresponding to the second signal.

According to an embodiment of the present invention, the step of determining whether the first signal conforms to the trigger condition includes determining whether the first signal is triggered by a specific switch.

According to an embodiment of the present invention, the step of determining whether the first signal conforms to the trigger condition includes determining whether the coordinate variation corresponding to the first signal is located within a specific area on the touch pad if the first signal is triggered by the touch pad.

According to an embodiment of the present invention, the step of determining whether the first signal conforms to the trigger condition includes determining whether the first signal is triggered by a compound key on a keyboard.

According to an embodiment of the present invention, the step of determining whether the first signal conforms to the trigger condition includes determining whether the first signal is triggered by an operation interface provided by a specific application program.

According to an embodiment of the present invention, the operation method further includes switching the touch pad to the first function mode when the first signal conforming to the trigger condition disappears.

According to an embodiment of the present invention, before the step of switching and maintaining the touch pad in the second function mode, the operation method includes providing a function reference table for recording the second kind of functions, partitioning the touch pad according to a number of the second kind of functions, respectively assigning the area corresponding to each of the second kind of functions according to the partition result, and recording a mapping relationship between each of the second kind of functions and the corresponding area into the function reference table.

According to an embodiment of the present invention, the step of executing the corresponding second kind of function according to the coordinate variation includes capturing a movement track of the second signal and executing the second kind of function corresponding to the area containing the coordinate variation according to a direction of the movement track.

According to an embodiment of the present invention, the touch pad executes a cursor moving function, an object selection function, and an object dragging function in the first function mode, and the second kind of functions may include an image scroll up/down function, an image scroll left/right function, and an image scale function.

The present invention provides an integration system of a touch pad with multiple function modes. The integration system includes a determination module, a switch module, and an execution module. The determination module receives a first signal and determines whether the first signal conforms to a trigger condition and exists continuously. The switch module is connected to the determination module, and when the first signal conforms to the trigger condition and exists continuously, the switch module switches the touch pad presently set to a first function mode to a second function mode and maintains the touch pad in the second function mode, wherein the second function mode includes a plurality of functions of a second kind, and each of the second kind of functions is respectively corresponding to an area on the touch pad. The execution module is connected to the switch module, and when a second signal is received through the touch pad, the first signal still exists, and the touch pad is in the second function mode, the execution module executes a corresponding one of the second kind of functions according to a coordinate variation corresponding to the second signal.

According to an embodiment of the present invention, the determination module determines whether the first signal is triggered by a specific switch.

According to an embodiment of the present invention, the determination module determines whether a coordinate variation corresponding to the first signal is located within a specific area on the touch pad when the first signal is triggered by the touch pad.

According to an embodiment of the present invention, the determination module determines whether the first signal is triggered by a compound key on a keyboard.

According to an embodiment of the present invention, the determination module determines whether the first signal is triggered by an operation interface provided by a specific application program.

According to an embodiment of the present invention, the switch module switches the touch pad to the first function mode when the first signal conforming to the trigger condition disappears.

According to an embodiment of the present invention, the switch module obtains a function reference table for recording the second kind of functions, partitions the touch pad according to a number of the second kind of functions, respectively assigns the area corresponding to each of the second kind of functions according to the partition result, and records a mapping relationship between each of the second kind of functions and the corresponding area into the function reference table.

According to an embodiment of the present invention, the execution module captures a movement track of the second signal and executes the second kind of function corresponding to the area containing the coordinate variation according to a direction of the movement track.

According to an embodiment of the present invention, the touch pad executes a cursor moving function, an object selection function, and an object dragging function in the first function mode, and the second kind of functions may include an image scroll up/down function, an image scroll left/right function, and an image scale function.

The present invention further provides a computer program product including a computer usable medium having a plurality of program instructions embodied therein, wherein the program instructions are suitable for being loaded into a computer system to execute following steps. First, a first signal is received and whether the first signal conforms to a trigger condition is determined. Then, if the first signal conforms to the trigger condition and exists continuously, a touch pad presently set to a first function mode is switched to and maintained in a second function mode, wherein the second function mode includes a plurality of functions of a second kind, and each of the second kind of functions is respectively corresponding to an area on the touch pad. Finally, a second signal is received through the touch pad, and a corresponding one of the second kind of functions is executed according to a coordinate variation corresponding to the second signal.

As described above, in the present invention, the trigger condition of a first signal is determined to decide whether to switch a touch pad from a first function mode to a second function mode, and when the first signal exists continuously, a corresponding second kind of function is executed according to the position of a second signal. Thereby, besides the conventional mouse functions, the touch pad further provides other functions through the areas partitioned therein after the touch pad enters the second function mode. As a result, a user can experience a totally different way in operating the touch pad.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of an integration system of a touch pad with multiple function modes according to an embodiment of the present invention.

FIG. 2 is a flowchart of an operation method of a touch pad with multiple function modes according to an embodiment of the present invention.

FIG. 3 is a diagram illustrating the appearance of a touch pad according to an embodiment of the present invention.

FIG. 4 is a schematic diagram of a computer system according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Below, embodiments of the present invention will be described with reference to accompanying drawings.

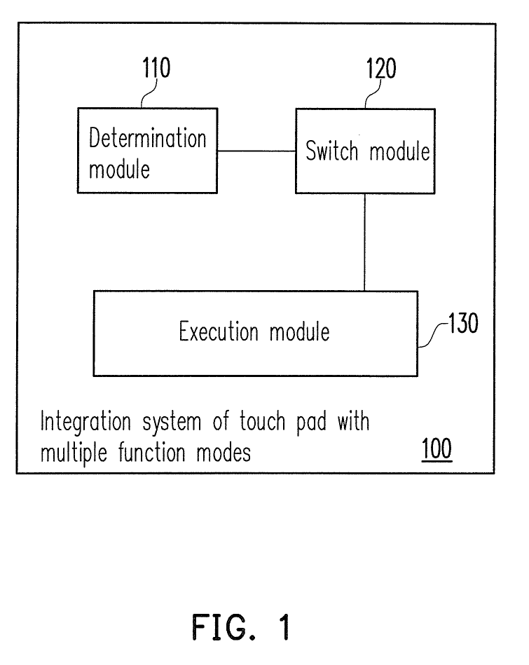

FIG. 1 is a diagram of an integration system of a touch pad with multiple function modes according to an embodiment of the present invention. Referring to FIG. 1, the touch pad integration system 100 includes a determination module 110, a switch module 120, and an execution module 130. The touch pad integration system 100 is used for integrating multiple function modes into the same touch pad, and switching the touch pad between different function modes according to the operations of a user so as to execute corresponding functions.

When a first signal is received, the determination module 110 determines whether the first signal conforms to a trigger condition and exists continuously. For example, the determination module 110 determines that the first signal conforms to the trigger condition when the first signal is triggered by a specific switch, wherein the specific switch may be a physical switch disposed outside the touch pad or in the centre of the touch pad; however, the type and position of the specific switch are not limited herein. Besides, if the first signal is triggered by the touch pad, the determination module 110 determines whether the first signal conforms to the trigger condition according to whether a coordinate variation corresponding to the first signal is located within a specific area on the touch pad. In addition, the determination module 110 may also determine whether the first signal conforms to the trigger condition according to whether the first signal is triggered by a compound key on a keyboard (for example, whether a user presses down several specific keys on the keyboard at the same time) or an operation interface provided by a specific application program.

The switch module 120 is connected to the determination module 110, and when the first signal conforms to the trigger condition and exists continuously, the switch module 120 switches the touch pad presently set to a first function mode to a second function mode and maintains the touch pad in the second function mode. In the present embodiment, the first function mode is a function mode originally set by the manufacturer of the touch pad, and the touch pad executes conventional mouse functions (for example, a cursor moving function, an object selection function, and an object dragging function) in the first function mode. The second function mode includes a plurality of functions of a second kind, and each of the second kind of functions is respectively corresponding to an area on the touch pad, wherein the second kind of functions may be any operation functions, and the type of the second kind of functions is not limited herein.

The execution module 130 is connected to the switch module 120, and when a second signal is received through the touch pad, the first signal still exists, and the touch pad is in the second function mode, the execution module 130 executes a corresponding second kind of function according to a coordinate variation corresponding to the second signal.

Through the operation of the touch pad integration system 100, the touch pad is switched from the first function mode to the second function mode as long as the first signal conforms to the trigger condition. When the first signal exists continuously, the touch pad remains in the second function mode so that the user can input the second signal through the touch pad to execute functions corresponding to the second function mode. Below, a touch pad operation method which integrates multiple function modes will be further described with reference to another embodiment of the present invention.

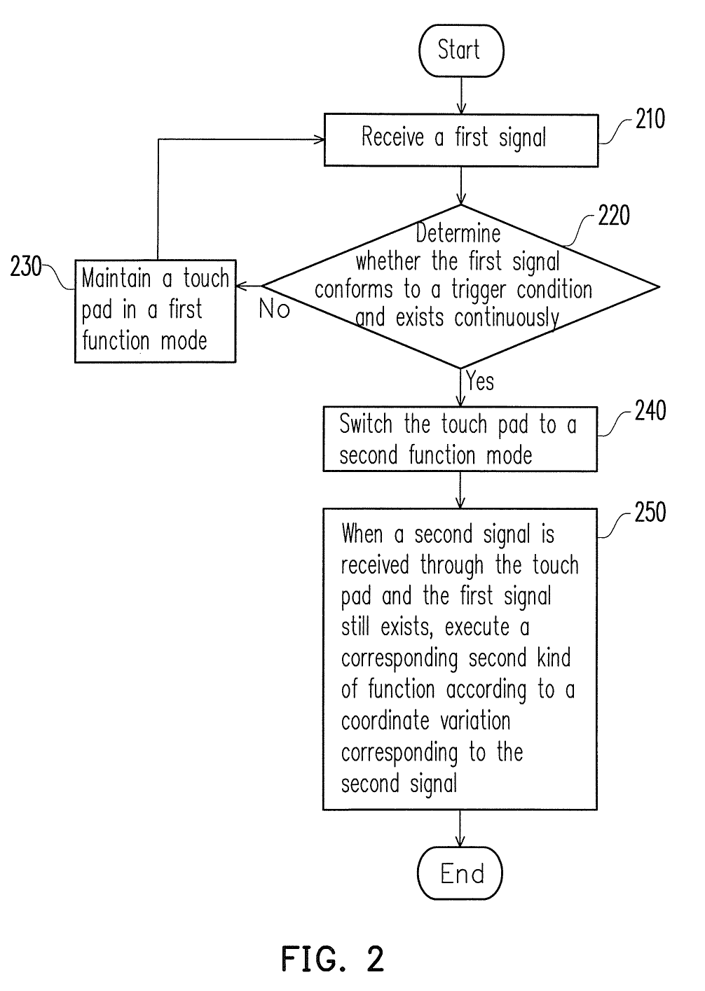

Referring to both FIG. 1 and FIG. 2, in the present embodiment, it is assumed that presently the touch pad is set to the first function mode. In this case, the touch pad is in a normal operation state, and a user can execute conventional mouse functions (for example, moving the cursor, selecting an object, or dragging an object, etc) by touching or clicking the touch pad. When the user wants to execute a special function by using the touch pad, the user can switch the function mode of the touch pad by triggering a first signal. In step 210, the touch pad integration system 100 receives the first signal triggered by the user, wherein the first signal may be triggered by a hardware switch, the touch pad, a compound key on a keyboard, or an operation interface provided by an application program; however, how the first signal is triggered is not limited herein.

Then, in step 220, the determination module 110 determines whether the first signal conforms to a trigger condition and exists continuously. A first signal conforming to the trigger condition may be a first signal triggered by a specific switch, a specific area on the touch pad, a compound key on a keyboard, or an operation interface provided by a specific application program. If the determination module 110 determines that the first signal does not conform to the trigger condition or the first signal disappears, then in step 230, the touch pad remains in the first function mode, and the process returns to step 210 to receive and process another first signal triggered by the user.

Contrarily, if the first signal conforms to the trigger condition and exists continuously, in step 240, the switch module 120 switches the touch pad from the first function mode to the second function mode and maintains the touch pad in the second function mode. To be specific, before the touch pad enters and remains in the second function mode, the switch module 120 first obtains a function reference table which records a plurality of second kind of functions. Then, the switch module 120 partitions the touch pad into a plurality of areas according to the number of the second kind of functions recorded in the function reference table. Next, the switch module 120 respectively assigns an area corresponding to each of the second kind of functions. Finally, the switch module 120 records the mapping relationship between the second kind of functions and the areas back into the function reference table. After foregoing steps are completed, the touch pad does not support the conventional mouse functions originally set by the manufacturer anymore as long as a first signal conforming to the trigger condition exists continuously. Instead, the touch pad provides different second kind of functions through the partitioned areas.

Finally, in step 250, when a second signal is received through the touch pad, and meanwhile, the first signal still exists and accordingly the touch pad remains in the second function mode, the execution module 130 executes a corresponding second kind of function according to a coordinate variation corresponding to the second signal. In the present embodiment, the execution module 130 first determines which area on the touch pad the coordinate variation corresponding to the second signal is located within and refers to the function reference table to obtain the second kind of function corresponding to this area. Then, the execution module 130 captures a movement track of the second signal and executes the second kind of function corresponding to the area in which the coordinate variation is located according to the direction of the movement track.

It has to be noted that the touch pad remains in the second function mode only when the first signal conforming to the trigger condition exists. In other words, once the first signal disappears, the switch module 120 instantly switches the touch pad back to the first function mode. In this case, the user can only perform those conventional mouse functions (for example, moving the cursor, selecting or dragging an object) by using the touch pad.

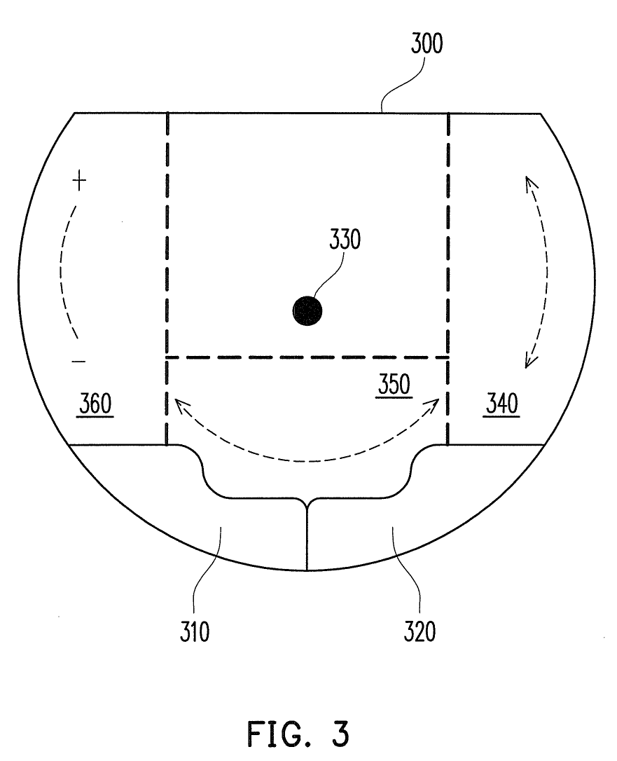

FIG. 3 is a diagram illustrating the appearance of a touch pad according to an embodiment of the present invention. Referring to FIG. 3, the touch pad 300 includes a button 310, a button 320, and a specific switch 330 in the centre, and the area except the button 310, the button 320, and the specific switch 330 is a touch operation area. In the present embodiment, the touch pad 300 is originally set to a first function mode, so that a user can move the cursor by running his/her finger on the touch pad 300 or select or drag an object by clicking the touch pad 300.

However, the touch pad 300 is switched from the first function mode to a second function mode if the user constantly presses the specific switch 330, wherein the second kind of functions in the second function mode may include an image scroll up/down function, an image scroll left/right function, and an image scale function which are respectively corresponding to an area 340, an area 350, and an area 360. In an embodiment of the present invention, since each area is corresponding to a different second kind of function, a corresponding icon or symbol may be printed within this area for indicating the range and function of the area.

For example, as shown in FIG. 3, the bold dotted lines printed on the touch pad 300 respectively indicate the ranges of the areas 340, 350, and 360, and the dotted arcs and arrows within the areas 340 and 350 indicate that the user can scroll the image correspondingly by running his/her finger up and down or left and right within these two areas. Namely, when the user constantly presses down the specific switch 330 with one finger and runs another finger up and down within the area 340, the image displayed in the screen can be quickly scrolled up and down, and when the user constantly presses down the specific switch 330 with one finger and runs another finger left and right within the area 350, the image displayed in the screen can be quickly scrolled left and right.

In addition, the dotted arcs and +/− signs within the area 360 are used for prompting the user that the image displayed in the screen can be zoomed out when the user runs his/her finger downwards within the area 360 and zoomed in when the user runs his/her finger upwards within the area 360. That is, when the user constantly presses down the specific switch 330 with one finger and runs another finger up and down within the area 360, the image scale function is executed so as to zoom in or out the image displayed in the screen.

As described above, the touch pad 300 is integrated with two different function modes and can be switched between these two function modes by simply pressing the specific switch 330. Accordingly, besides the functions originally set by the manufacturer of the touch pad 300, the user can also execute other kinds of functions by operating different areas on the touch pad 300 after the touch pad 300 is switched to the second function mode. Accordingly, the operation of the touch pad 300 is made more interesting and convenient.

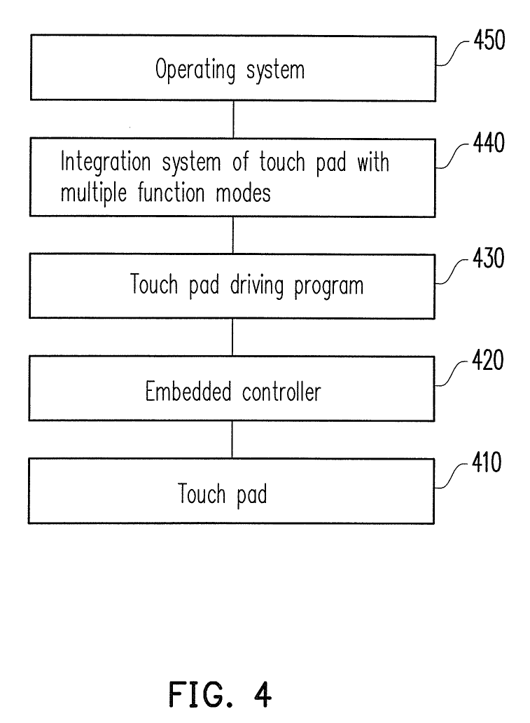

FIG. 4 is a schematic diagram of a computer system according to an embodiment of the present invention. In the present embodiment, when a user uses a touch pad 410, information (for example, the coordinate variation) corresponding to the operation is sent upwards to a touch pad integration system 440 with multiple function modes through a embedded controller 420 and a touch pad driving program 430. The touch pad integration system 440 then determines which function mode the touch pad 410 is presently in and which function it should execute through the same or a similar procedure as illustrated in FIG. 2, so that an operating system 450 can respond correctly according to the determination result of the touch pad integration system 440.

In other words, regardless of which manufacturer manufactures the touch pad 410 or whether the pre-planed functions and pre-defined hardware signals are the same, through the operation of the touch pad integration system 440, the touch pad 410 can be switched from a function mode previously set by the manufacturer to another function mode and provide various specially defined functions through different areas. Namely, a touch pad designed by any manufacturer allows a user to execute specially-designed functions on an operating system by adopting the touch pad integration system 440 with multiple function modes.

The present invention further provides a computer program product for executing the aforementioned touch pad operation method with multiple function modes. The computer program product comprises a computer usable medium having a plurality of program instructions (for example, a setting program instruction and a deployment program instruction, etc) embodied therein. These program instructions can be loaded into a computer system and executed by the same to complete foregoing steps in the touch pad operation method with multiple function modes, so that the computer system can act as a touch pad integration system with multiple function modes.

As described above, the present invention provides an operation method of a touch pad with multiple function modes, an integration system, thereof, and a computer program product using the operation method, wherein a conventional function mode and a specially defined function mode are integrated into the same touch pad, and when it is determined that a first signal conforms to a trigger condition and exist continuously, the touch pad is divided into a plurality of areas and different functions are respectively assigned to these areas. Thereby, a corresponding function can be executed when a user constantly triggers the first signal and runs his/her finger on the touch pad to generate a second signal. Accordingly, the functionality of the touch pad is not limited by its original settings, and the touch pad can also provide other special functions after the function mode thereof is switched. As a result, the operation of the touch pad is made more interesting and convenient.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An operation method of a touch pad with multiple function modes, wherein the touch pad is set to a first function mode, the operation method comprising:
receiving a first signal, and determining whether the first signal conforms to a trigger condition;
if the first signal conforms to the trigger condition and exists continuously, switching the touch pad from the first function mode to a second function mode and maintaining the touch pad in the second function mode, wherein the second function mode comprises a plurality of functions of a second kind, and each of the second kind of functions is respectively corresponding to an area on the touch pad;
receiving a second signal through the touch pad, and the first signal still existing; and
executing a corresponding one of the second kind of functions according to a coordinate variation corresponding to the second signal.

2. The operation method according to claim 1, wherein the step of determining whether the first signal conforms to the trigger condition comprises:
determining whether the first signal is triggered by a specific switch.

3. The operation method according to claim 1, wherein the step of determining whether the first signal conforms to the trigger condition comprises:
if the first signal is triggered by the touch pad, determining whether the coordinate variation corresponding to the first signal is located within a specific area on the touch pad.

4. The operation method according to claim 1, wherein the step of determining whether the first signal conforms to the trigger condition comprises:
determining whether the first signal is triggered by a compound key on a keyboard.

5. The operation method according to claim 1, wherein the step of determining whether the first signal conforms to the trigger condition comprises:
determining whether the first signal is triggered by an operation interface provided by a specific application program.

6. The operation method according to claim 1, further comprising:
switching the touch pad to the first function mode when the first signal conforming to the trigger condition disappears.

7. The operation method according to claim 1, wherein before the step of switching the touch pad to the second function mode and maintaining the touch pad in the second function mode, the operation method further comprises:
providing a function reference table for recording the second kind of functions;
partitioning the touch pad according to a number of the second kind of functions;
respectively assigning the area corresponding to each of the second kind of functions according to the partition result; and
recording a mapping relationship between each of the second kind of functions and the corresponding area into the function reference table.

8. The operation method according to claim 7, wherein the step of executing the corresponding one of the second kind of functions according to the coordinate variation comprises:
capturing a movement track of the second signal; and
executing the second kind of function corresponding to the area containing the coordinate variation according to a direction of the movement track.

9. The operation method according to claim 1, wherein the touch pad executes a cursor moving function, an object selection function, and an object dragging function in the first function mode.

10. The operation method according to claim 1, wherein the second kind of functions comprise an image scroll up/down function, an image scroll left/right function, and an image scale function.

11. An integration system of a touch pad with multiple function modes, comprising:
a determination module, for determining whether a first signal conforms to a trigger condition and exists continuously when the first signal is received;
a switch module, coupled to the determination module, for switching the touch pad presently set to a first function mode to a second function mode and maintaining the touch pad in the second function mode when the first signal conforms to the trigger condition and exists continuously, wherein the second function mode comprises a plurality of functions of a second kind, and each of the second kind of functions is respectively corresponding to an area on the touch pad; and
an execution module, coupled to the switch module, for executing a corresponding one of the second kind of functions according to a coordinate variation corresponding to a second signal when the second signal is received through the touch pad, the first signal still exists, and the touch pad is in the second function mode.

12. The integration system according to claim 11, wherein the determination module determines whether the first signal is triggered by a specific switch.

13. The integration system according to claim 11, wherein the determination module determines whether the coordinate variation corresponding to the first signal is located within a specific area on the touch pad when the first signal is triggered by the touch pad.

14. The integration system according to claim 11, wherein the determination module determines whether the first signal is triggered by a compound key on a keyboard.

15. The integration system according to claim 11, wherein the determination module determines whether the first signal is triggered by an operation interface provided by a specific application program.

16. The integration system according to claim 11, wherein the switch module switches the touch pad to the first function mode when the first signal conforming to the trigger condition disappears.

17. The integration system according to claim 11, wherein the switch module obtains a function reference table for recording the second kind of functions, partitions the touch pad according to a number of the second kind of functions, respectively assigns the area corresponding to each of the second kind of functions according to the partition result, and records a mapping relationship between each of the second kind of functions and the corresponding area into the function reference table.

18. The integration system according to claim 17, wherein the execution module captures a movement track of the second signal and executes the second kind of function corresponding to the area containing the coordinate variation according to a direction of the movement track.

19. The integration system according to claim 11, wherein the touch pad executes a cursor moving function, an object selection function, and an object dragging function in the first function mode.

20. The integration system according to claim 11, wherein the second kind of functions comprise an image scroll up/down function, an image scroll left/right function, and an image scale function.

21. A computer program product, comprising a computer usable medium having a plurality of program instructions embodied therein, wherein the program instructions are suitable for being loaded into a computer system to execute following steps:
receiving a first signal, and determining whether the first signal conforms to a trigger condition;
if the first signal conforms to the trigger condition and exists continuously, switching a touch pad presently set to a first function mode to a second function mode and maintaining the touch pad in the second function mode, wherein the second function mode comprises a plurality of functions of a second kind, and each of the second kind of functions is respectively corresponding to an area on the touch pad;
receiving a second signal through the touch pad, and the first signal still existing; and
executing a corresponding one of the second kind of functions according to a coordinate variation corresponding to the second signal.

22. The computer program product according to claim 21, wherein when the program instructions determine whether the first signal conforms to the trigger condition, the program instructions determine whether the first signal is triggered by a specific switch.

23. The computer program product according to claim 21, wherein when the program instructions determine whether the first signal conforms to the trigger condition, the program instructions determine whether the coordinate variation corresponding to the first signal is located within a specific area on the touch pad if the first signal is triggered by the touch pad.

24. The computer program product according to claim 21, wherein when the program instructions determine whether the first signal conforms to the trigger condition, the program instructions determine whether the first signal is triggered by a compound key on a keyboard.

25. The computer program product according to claim 21, wherein when the program instructions determine whether the first signal conforms to the trigger condition, the program instructions determine whether the first signal is triggered by an operation interface provided by a specific application program.

26. The computer program product according to claim 21, wherein the program instructions further switch the touch pad to the first function mode when the first signal conforming to the trigger condition disappears.

27. The computer program product according to claim 21, wherein before the program instructions switch the touch pad to the second function mode and maintain the touch pad in the second function mode, the program instructions obtain a function reference table for recording the second kind of functions, partition the touch pad according to a number of the second kind of functions, respectively assign the area corresponding to each of the second kind of functions according to the partition result, and record a mapping relationship between each of the second kind of functions and the corresponding area into the function reference table.

28. The computer program product according to claim 27, wherein when the program instructions execute the corresponding one of the second kind of functions according to the coordinate variation, the program instructions capture a movement track of the second signal and execute the second kind of function corresponding to the area containing the coordinate variation according to a direction of the movement track.

29. The computer program product according to claim 21, wherein the touch pad execute a cursor moving function, an object selection function, and an object dragging function in the first function mode.

30. The computer program product according to claim 21, wherein the second kind of functions comprise an image scroll up/down function, an image scroll left/right function, and an image scale function.
